(19) United States
(12) Patent Application Publication
(10) Pub. No.: US 2010/0119105 A1
(43) Pub. Date: May 13, 2010

(54) Image processing device and image processing progam

(76) Inventors: Koichi Moriya, Chiba-shi (JP); Kazuo Tani, Chiba-shi (JP); Akira Kawanaka, Tokyo (JP); Hirokazu Kobayashi, Kanagawa (JP); Takaaki Suzuki, Tokyo (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/589,595

(22) Filed: Oct. 26, 2009

(30) Foreign Application Priority Data
Oct. 28, 2008 (JP) 2008-277304

(51) Int. Cl. G06K 9/00

(52) U.S. Cl. 382/100

(57) ABSTRACT

Provided is a technology of embedding watermark data into an arbitrarily-shaped region by applying a wavelet transform. Prepared are: image data into which the watermark data is to be embedded; a shape map that defines the arbitrarily-shaped region into which the watermark data is to be embedded within the image data; and the watermark data. An SA-DWT processing unit uses the shape map to recognize a given region included in the arbitrarily-shaped region within the image data, and subjects image data in the given region to the wavelet transform. The wavelet transform causes the image data in the arbitrarily-shaped region to be divided into frequency bands, and a watermark data embedding unit embeds the watermark data into a frequency space of the image data generated by the dividing. An SA-IDWT processing unit subjects the resultant to an inverse wavelet transform, and watermark-embedded image data is generated.

### BACKGROUND OF THE INVENTION

1. Field of the Invention

The present invention relates to an image processing device and an image processing program, for example, a technology for dividing an image into frequency bands by using a wavelet transform.

2. Description of the Related Art

Recently, research in the digital watermarking that embeds watermark data in image data (digital image) has been very active.

The watermark data is inconspicuously embedded in an image, and can provide the image with additional information while reducing an influence exerted upon visibility of the image to a minimum.

There are various kinds of method of utilizing the watermark data. For example, information associated with a uniform resource locator (URL) of a predetermined website is previously embedded in an image as the watermark data to allow a user to photograph the image with a cellular phone equipped with a camera and then allow the cellular phone to detect the watermark data and to access the website.

There are various kinds of method of embedding the watermark data into an image, examples of which include the following “Image Processor, Program, and Storage Medium” disclosed in JP 2004-221950 A, in which the wavelet transform is used.

The wavelet transform is a transform method employed in JPEG2000, and has been increasing in importance in recent years.

In this technology, an image is divided into a plurality of rectangle regions, and a transform coefficient based on the wavelet transform is extracted from each of the rectangular regions.

Then, in a rectangle region having a large number of high-frequency components, a strength of a watermark is set to “strong” because a watermark is inconspicuous, while in the rectangle region that does not have such a large number of high-frequency components, the strength of the watermark is set to “weak” because the watermark is conspicuous.

There has been proposed a technology for embedding watermark data into a rectangle region by using the wavelet transform, such as the technology disclosed in JP 2004-221950 A, but there has never been proposed a method of embedding the watermark data into a region having an arbitrary shape by using the wavelet transform.

If it is possible to subject the region having an arbitrary shape to the wavelet transform and to embed the watermark data thereinto, it becomes possible to embed the watermark data into only an arbitrarily-shaped region in which the watermark is inconspicuous within the image, or by setting an entirety of an image having an arbitrary shape as an embedding-target region, it becomes possible to embed the watermark data into the image having the arbitrary shape.

### SUMMARY OF THE INVENTION

It is therefore an object of the present invention to embed watermark data into an arbitrarily-shaped region by applying a wavelet transform.

In order to achieve the above-mentioned object, according to a first aspect of the present invention, there is provided an image processing device, comprising: division image data acquiring means for acquiring division image data obtained by dividing image data into which watermark data is to be embedded into frequency bands by a wavelet transform; division region data acquiring means for acquiring division region data obtained by dividing, into the frequency bands, region data that defines a region into which the watermark data is to be embedded within the image data; and embedding means for embedding the watermark data into the division image data corresponding to a region defined by the acquired division region data.

According to a second aspect of the present invention, there is provided an image processing device according to the first aspect, wherein: the division image data acquiring means acquires the division image data obtained by dividing the region defined by the region data within the image data; and the embedding means embeds the watermark data into the acquired division image data.

According to a third aspect of the present invention, there is provided an image processing device according to the first aspect, wherein: the division image data acquiring means acquires the division image data obtained by dividing an entirety of the image data; and the embedding means embeds the watermark data into the region defined by the acquired division region data within the division image data.

According to a fourth aspect of the present invention, there is provided an image processing device according to any one of the first to third aspects, further comprising boundary identifying means for identifying, with use of the acquired division region data, a boundary of the region into which the watermark data is to be embedded within the division image data, wherein the embedding means embeds the watermark data preferentially inside the identified boundary.

According to a fifth aspect of the present invention, there is provided an image processing device according to the fourth aspect, wherein the division region data acquiring means acquires the division region data by dividing the region data into the frequency bands.

According to a sixth aspect of the present invention, there is provided an image processing device according to the fifth aspect, wherein the embedding means embeds the watermark data into a predetermined frequency band.

Examples of the predetermined frequency band may include frequency bands excluding a frequency band of the highest frequency, a specified frequency band, and a frequency band lower than the specified frequency band.

According to a seventh aspect of the present invention, there is provided an image processing device according to the sixth aspect, further comprising watermark-embedded image data generating means for generating watermark-embedded image data by compositing the division image data in which the watermark data is embedded by the embedding means.

According to an eighth aspect of the present invention, there is provided an image processing device comprising: watermark-embedded image data acquiring means for acquiring watermark-embedded image data in which watermark data is embedded; division watermark-embedded image data acquiring means for acquiring division watermark-embedded image data by dividing the acquired watermark-embedded image data into frequency bands by a wavelet transform; division region data acquiring means for acquiring division region data obtained by dividing, into the frequency bands, region data that defines a region in which the watermark data is embedded within the watermark-embedded image data; and reading means for reading the watermark data from the division watermark-embedded image data corresponding to a region defined by the acquired division region data.

According to a ninth aspect of the present invention, there is provided an image processing device according to the eighth aspect, wherein: the division watermark-embedded image data acquiring means acquires the division watermark-embedded image data obtained by dividing the region defined by the region data within the acquired watermark-embedded image data; and the reading means reads the watermark data from the acquired division watermark-embedded image data.

According to a tenth aspect of the present invention, there is provided an image processing device according to the eighth aspect, wherein: the division watermark-embedded image data acquiring means acquires the division watermark-embedded image data obtained by dividing an entirety of the watermark-embedded image data; and the reading means reads the watermark data from the region defined by the acquired division region data within the division watermark-embedded image data.

According to an eleventh aspect of the present invention, there is provided an image processing device according to any one of the eighth to tenth aspects, further comprising boundary identifying means for identifying, with use of the acquired division region data, a boundary of the region wherein the watermark data is embedded within the division watermark-embedded image data, wherein the reading means reads the watermark data from inside the identified boundary.

According to a twelfth aspect of the present invention, there is provided an image processing device according to the eleventh aspect, wherein the division region data acquiring means acquires the division region data by dividing the region data into the frequency bands.

According to a thirteenth aspect of the present invention, there is provided an image processing program for causing a computer to implement: a division image data acquiring function of acquiring division image data obtained by dividing image data into which watermark data is to be embedded into frequency bands; a division region data acquiring function of acquiring division region data obtained by dividing, into the frequency bands, region data that defines a region into which the watermark data is to be embedded within the image data; and an embedding function of embedding the watermark data into the division image data corresponding to a region defined by the acquired division region data.

According to a fourteenth aspect of the present invention, there is provided an image processing program for causing a computer to implement: a watermark-embedded image data acquiring function of acquiring watermark-embedded image data in which watermark data is embedded; a division watermark-embedded image data acquiring function of acquiring division watermark-embedded image data by dividing the acquired watermark-embedded image data into frequency bands; a division region data acquiring function of acquiring division region data obtained by dividing, into the frequency bands, region data that defines a region in which the watermark data is embedded within the watermark-embedded image data; and a reading function of reading the watermark data from the division watermark-embedded image data corresponding to a region defined by the acquired division region data.

According to the present invention, by using a shape map that defines an arbitrary shape, it is possible to embed the watermark data into the arbitrarily-shaped region by applying the wavelet transform.

### BRIEF DESCRIPTION OF THE DRAWINGS

In the accompanying drawings:

FIG. 1 is a diagram for describing a configuration of an image processing device in terms of hardware;

FIGS. 2A and 2B are diagrams illustrating examples of a shape map and an image corresponding thereto;

FIGS. 3A and 3B are diagrams for describing a watermark data embedding processing and a watermark data reading processing;

FIG. 4 is a diagram for describing a method of subjecting an arbitrarily-shaped region to a wavelet transform;

FIG. 5 is a diagram for describing an octave division;

FIGS. 6A to 6C are diagrams for describing an example of subjecting the image to the octave division;

FIGS. 7A to 7C are diagrams for describing an example of subjecting the shape map to the octave division;

FIG. 8 is a diagram for describing a method of subjecting the arbitrarily-shaped region to an inverse wavelet transform;

FIG. 9 is a diagram for describing a division level desirable for embedding the watermark data;

FIG. 10 is a flowchart for describing a watermark embedding processing;

FIG. 11 is a flowchart for describing a watermark reading processing; and

FIGS. 12A and 12B are diagrams for describing an example of utilizing the image data in which the watermark data is embedded.

### DETAILED DESCRIPTION OF THE PREFERRED EMBODIMENTS

### (1) Outline of Embodiment

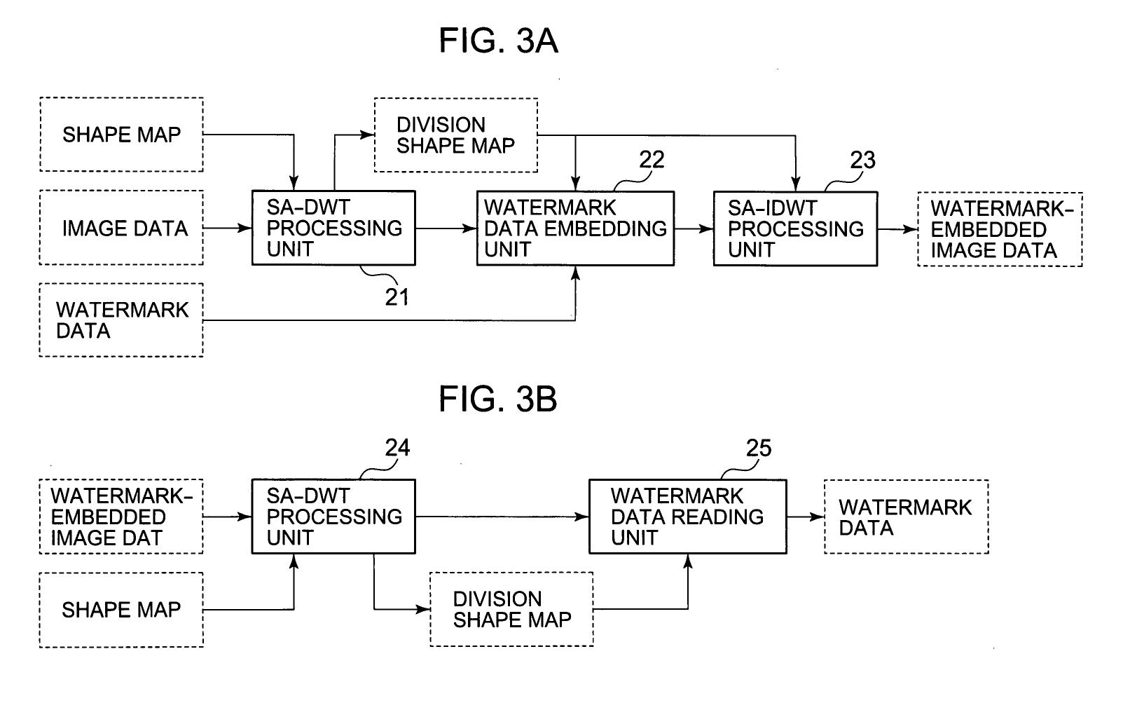

As illustrated in FIG. 3A, there are prepared: image data into which watermark data is to be embedded; a shape map that defines an arbitrarily-shaped region into which the watermark data is to be embedded within the image data; and the watermark data.

An SA-DWT processing unit 21 uses the shape map to recognize a given region included in the arbitrarily-shaped region within the image data, and subjects image data in the given region to an (arbitrarily-shaped) wavelet transform.

The wavelet transform causes the image data in the arbitrarily-shaped region to be divided into frequency bands, and a watermark data embedding unit 22 embeds the watermark data into a frequency space of the image data generated by the dividing.

An SA-IDWT processing unit 23 subjects the resultant to an inverse wavelet transform, and watermark-embedded image data is generated.

With regard to reading of the watermark data, as illustrated in FIG. 3B, an SA-DWT processing unit 24 uses the shape map to recognize the arbitrarily-shaped region in which the watermark data is embedded within the watermark-embedded image data, subjects the arbitrarily-shaped region to the wavelet transform, and divides the resultant into frequency bands.

Then, the watermark data reading unit 25 reads the watermark data from the frequency space of the image data generated by the dividing.

### (2) Details of Embodiment

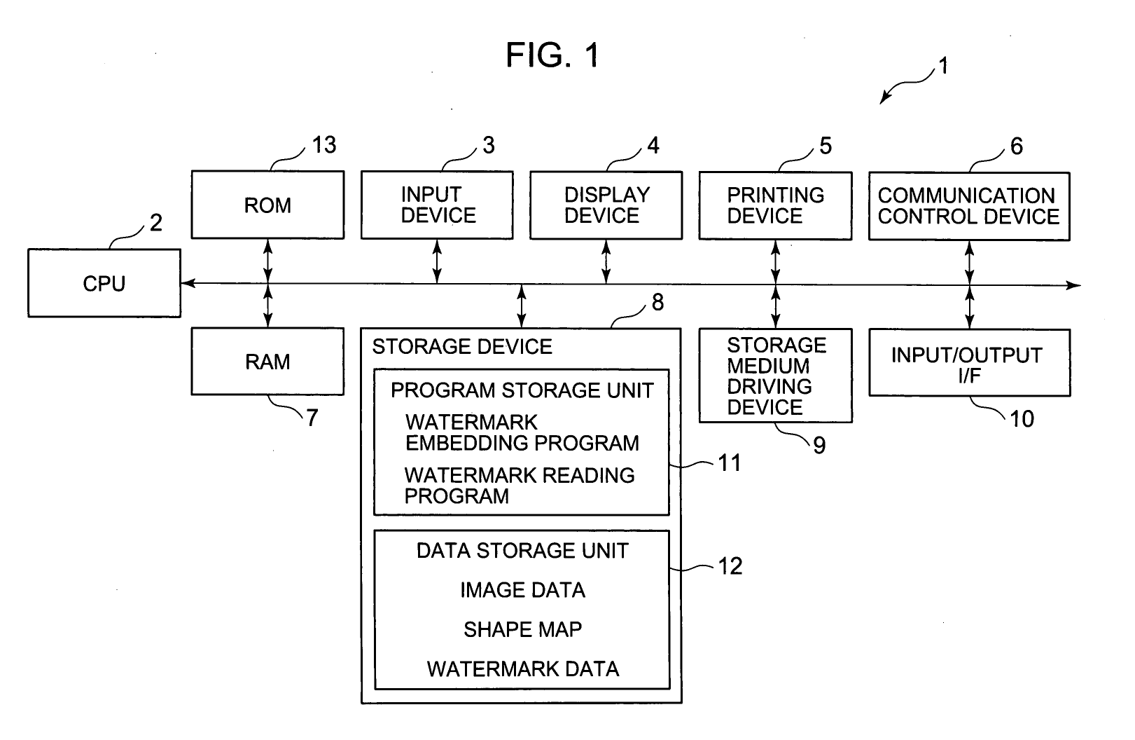

FIG. 1 is a diagram for describing a configuration of an image processing device 1 according to this embodiment in terms of hardware.

The image processing device 1 includes functional units, which are connected to each other via a bus line, such as a central processing unit (CPU) 2, a random access memory (RAM) 7, a read only memory (ROM) 13, an input device 3, a display device 4, a printing device 5, a communication control device 6, a storage device 8, a storage medium driving device 9, and an input/output interface (I/F) 10.

The CPU 2 is a central processing device which carries out, according to a predetermined program, various types of arithmetic processing and information processing, and controls respective components constituting the image processing device 1.

The CPU 2, for example, executes a watermark embedding program stored in a program storage unit 11 to subject the arbitrarily-shaped region of the image data to the wavelet transform and to embed the watermark data into the resultant, or executes a watermark reading program to subject the arbitrarily-shaped region of the image data to the inverse wavelet transform and to read the watermark data.

The ROM 13 is a memory used exclusively for reading in which principal programs and data used for operating the image processing device 1 are stored.

The RAM 7, which is a readable and writable memory for providing a working memory for the CPU 2 to operate, provides a working memory for the CPU 2 to embed the watermark data into the image data or to read the embedded watermark data from the image data.

The input device 3 includes operation devices such as a keyboard and a mouse, and is used when a user operates the image processing device 1.

The display device 4 includes a display device such as a liquid crystal display, and displays various screens when the user operates the image processing device 1, such as an operation screen used when the watermark data is embedded into the image data and an operation screen used when the watermark data is read from the image data.

The communication control device 6 is a device for connecting the image processing device 1 to a communication network such as the Internet. The image processing device 1 can perform communications with various kinds of server devices and terminal devices via the communication control device 6, and can receive the image data into which the watermark data is to be embedded and the watermark data from an external portion, or can transmit the image data in which the watermark data is embedded.

The printing device 5 includes a printer such as a laser printer, an inkjet printer, or a thermal transfer printer, and can print image data having the watermark embedded therein.

The input/output I/F 10 is an interface for connection to various types of external devices, and connects the image processing device 1 with a scanner or a digital camera, thereby providing a configuration for taking the image data into which the watermark data is to be embedded into the image processing device 1 with the aid of the connected scanner or digital camera.

The storage medium driving device 9 is a functional unit for driving amounted removable storage medium to read and write data.

The image processing device 1 can use the storage medium driving device 9 to read the image data into which the watermark data is to be embedded and the watermark data from the storage medium, and to write the image data in which the watermark data is embedded into the storage medium.

A readable/writable storage medium includes an optical disk, a magneto-optical disk, and a magnetic disk, and image data can be read therefrom and image data and other data can be written thereinto in a case of a writable storage medium.

The storage device 8 is a large-capacity and readable/writable storage device which includes a hard disk or the like.

In the storage device 8, the program storage unit 11 for storing programs and a data storage unit 12 for storing data are formed.

The program storage unit 11 stores an operating system (OS) serving as a basic software for causing the image processing device 1 to operate, the watermark embedding program, the watermark reading program, and other such programs.

Meanwhile, the data storage unit 12 stores the image data into which the watermark data is to be embedded, the shape map that defines the arbitrarily-shaped region into which the watermark data is to be embedded, the watermark data, and other such data.

Next, description is made of the image data and the shape map.

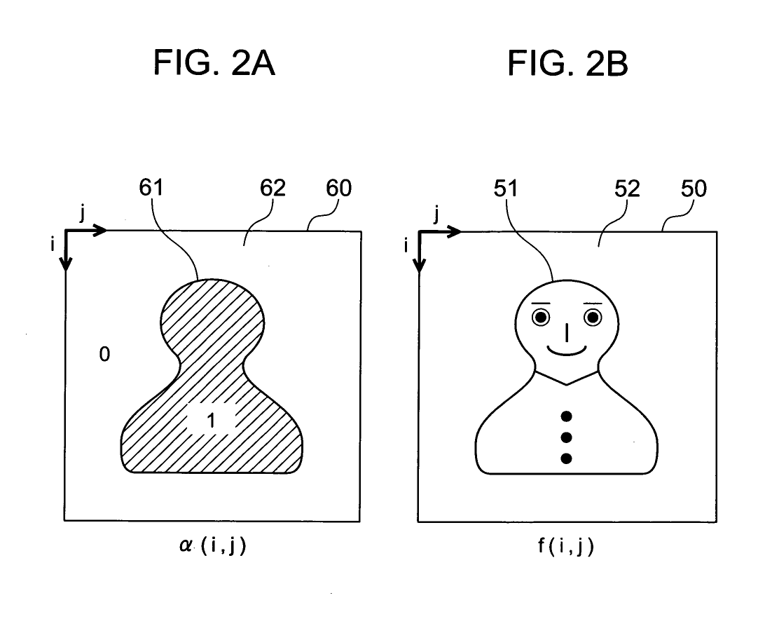

FIG. 2A is a diagram illustrating an example of the shape map.

The image processing device 1 subjects the arbitrarily-shaped region of the image to the wavelet transform and embeds the watermark data thereinto, in which the shape map serves as information useful for the image processing device 1 to recognize the arbitrarily-shaped region.

A shape map 60 illustrated in FIG. 2A has an i-axis and a j-axis set in a horizontal direction and a vertical direction, respectively, and is set such that a value of a pixel α(i,j) becomes “1” in an arbitrarily-shaped region 61 into which the watermark data is to be embedded and “0” in the other region, that is, a non-arbitrarily-shaped region 62.

The shape map 60 is prepared by being created by a user who desires to embed the watermark data.

FIG. 2B is a diagram illustrating an example of the image into which the watermark data is to be embedded.

A pixel f(i,j) of an image 50 corresponds to the pixel α(i,j) of the shape map 60, in which an arbitrarily-shaped region 51 corresponding to the arbitrarily-shaped region 61 within the shape map 60 becomes a region to be subjected to the wavelet transform, into which the watermark data is to be embedded.

A value of the pixel f(i,j) is, for example, a brightness or, if the image data includes RGB, a value thereof such as an R value.

By putting the image 50 into contrast with the shape map 60, the image processing device 1 can recognize the arbitrarily-shaped region 51 into which the watermark data is to be embedded and a non-arbitrarily-shaped region 52 into which the watermark data is not to be embedded within the image 50.

Note that in this example, an entirety of a person illustrated in the image of FIG. 2B equals to the arbitrarily-shaped region 51, but if the shape map 60 is set so that, for example, a face portion of the person may coincide with the arbitrarily-shaped region 51, the image processing device 1 subjects the face portion of the person to the wavelet transform, and embeds the watermark data thereinto.

Accordingly, in this embodiment, it is possible to subject a region having an arbitrary shape to the wavelet transform and to embed the watermark data thereinto, and hence the watermark data can be embedded into a partial region within the image as the arbitrarily-shaped region, or by setting an entire shape of the image as an arbitrary shape, the watermark data can also be embedded into the entirety of the image having the arbitrary shape.

In general, a region having a large number of high-frequency components within the image is characterized in that the watermark data is inconspicuous, and hence by setting the region in which the watermark data is inconspicuous within the image as the arbitrarily-shaped region, a more enhanced effect is produced.

In this case, the image processing device 1 is configured to analyze the region having a large number of high-frequency components within the image to automatically set the region as the arbitrarily-shaped region.

Alternatively, the image processing device 1 can be configured to recognize an edge of the image to set a region enclosed by the edge as the arbitrarily-shaped region.

Next, description is made of a watermark data embedding processing and a watermark data reading processing.

FIG. 3A is a diagram for describing the watermark data embedding processing.

There are prepared the shape map, the image data, and the watermark data in advance.

The SA-DWT processing unit 21, the watermark data embedding unit 22, and the SA-IDWT processing unit 23 are function units implemented by the CPU 2 executing the watermark embedding program.

Here, the SA-DWT represents the abbreviation of “shape-adaptive discrete wavelet transform”, which means a discrete wavelet transform for an arbitrary shape, while the SA-IDWT represents the abbreviation of “shape-adaptive inverse discrete wavelet transform”, which means an inverse wavelet transform for an arbitrary shape.

In the following description, the SA-DWT and the SA-IDWT are referred to simply as “wavelet transform” and “inverse wavelet transform”, respectively.

First, the SA-DWT processing unit 21 subjects the shape map to the wavelet transform, and creates a division shape map corresponding to a division level (the number of octave divisions, which is described later) of the image data.

Note that in a case of the shape map, a division may be performed only on a portion with the pixel α(i,j) being “1”, and hence results can be obtained only by downsampling the region having the pixel α(i,j) without performing filtering described later.

Subsequently, the SA-DWT processing unit 21 uses the shape map to recognize the arbitrarily-shaped region within the image data, and subjects the region to the wavelet transform.

Therefore, image data corresponding to the arbitrarily-shaped region is turned into transform coefficients in frequency spaces obtained by dividing the image data into frequency bands (subbands). The dividing is performed as the octave division, details of which are described later.

In a case of further performing the octave division on the image data divided into the transform coefficients in the frequency spaces, the SA-DWT processing unit 21 uses the corresponding division shape map to recognize the arbitrarily-shaped region in the frequency space, performs the wavelet transform, and divides the resultant.

The arbitrarily-shaped region of the division shape map is divided in correspondence with the frequency space, and hence the watermark data embedding unit 22 can reference the arbitrarily-shaped region of the division shape map to recognize the arbitrarily-shaped region in the frequency space. Accordingly, it is possible to further divide the transform coefficient of the arbitrarily-shaped region in a given frequency space.

After the arbitrarily-shaped region of the image data has been divided in the above-mentioned manner, the watermark data embedding unit 22 then uses the division shape map to embed the watermark data into the frequency space.

For example, in order to embed the watermark data into a frequency space at a division level 2, the watermark data embedding unit 22 references division shape map at the division level 2 to recognize the arbitrarily-shaped region in the frequency space at the division level 2, and embeds the watermark data into the region.

After the watermark data is thus embedded into the frequency space, the SA-IDWT processing unit 23 subjects the transform coefficient in the frequency space to the inverse wavelet transform to thereby generate the watermark-embedded image data in which the watermark data is embedded.

Accordingly, it is possible to obtain image data having a predetermined frequency band in which the watermark data is embedded, and if the image data is used to print or display an image, the image having the predetermined frequency band in which the watermark data is embedded is formed.

FIG. 3B is a diagram for describing the watermark data reading processing.

There are prepared the watermark-embedded image data and the shape map in advance.

The SA-DWT processing unit 24 and the watermark data reading unit 25 are function units implemented by the CPU 2 executing the watermark reading program.

Note that the SA-DWT processing unit 21 and the SA-DWT processing unit 24 have the same function, and hence a module for performing a processing corresponding thereto may be shared by the watermark embedding program and the watermark reading program.

First, the SA-DWT processing unit 24 divides the image data by the number of division levels for the division thereof, and generates the division shape map.

Note that the division shape map is the same as the one used in the watermark data embedding processing, and hence the image processing device 1 may be configured to use the division shape map used in the watermark data embedding processing, thereby omitting the processing of dividing the shape map.

Subsequently, the SA-DWT processing unit 24 uses the shape map to recognize the arbitrarily-shaped region within the watermark-embedded image data, and subjects the region to the wavelet transform.

In order to further perform the division, the SA-DWT processing unit 24 uses the division shape map to recognize the arbitrarily-shaped region in the frequency space, and repeats the division by a necessary number of division levels.

Therefore, the image data corresponding to the arbitrarily-shaped region in which the watermark data is embedded is divided, and the transform coefficients in the frequency spaces are obtained. The transform coefficients have the watermark data embedded therein.

Then, the watermark data reading unit 25 references the division shape map to recognize the arbitrarily-shaped region in the frequency space, and reads the watermark data from the arbitrarily-shaped region.

In the above-mentioned manner, it is possible to embed the watermark data into the arbitrarily-shaped region of the image data, and to read the watermark data.

Further, in the above-mentioned example, the image processing device 1 performs both the embedding of the watermark data and the reading thereof, which is a mere example, and the image processing device 1 can be configured by causing another information processing device to perform the watermark data embedding processing and the watermark data reading processing.

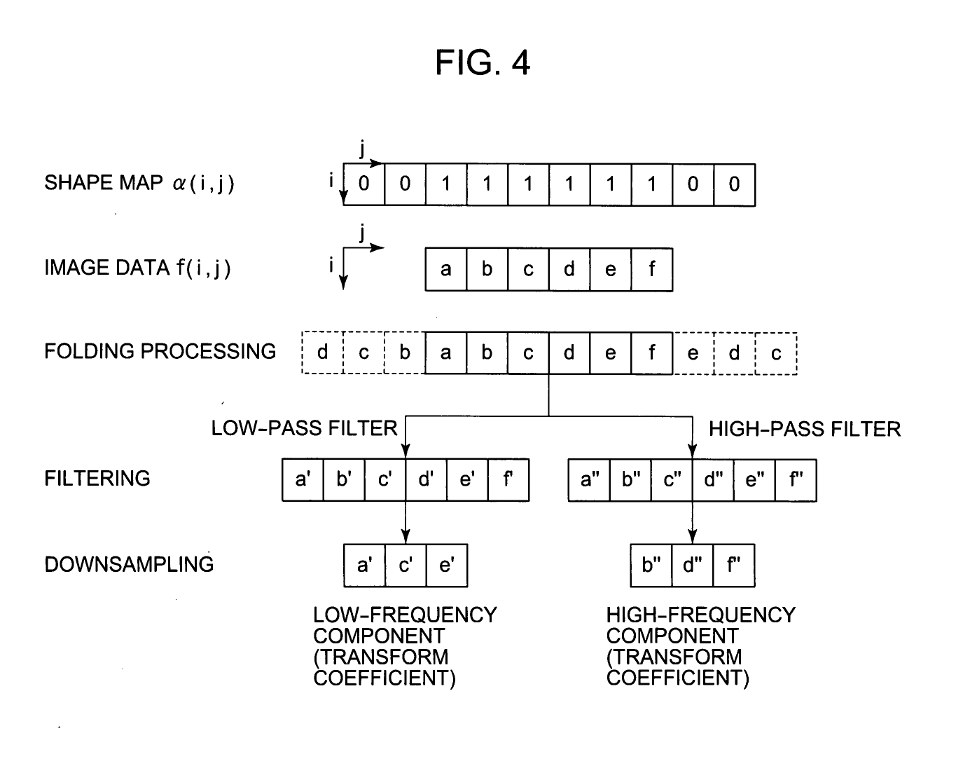

Next, FIG. 4 is used to describe a method of subjecting the arbitrarily-shaped region to the wavelet transform.

First, as illustrated in FIG. 4, there is assumed to be a shape map in which the pixel α(i,j) is expressed as (0011111100) in the horizontal direction.

The image processing device 1 recognizes pixels of image data which correspond to the pixel α(i,j)=1 as the arbitrarily-shaped region into which the watermark data is to be embedded, and it is assumed that, as illustrated in FIG. 4, the pixel value is (abcdef).

The image processing device 1 sets the pixel f(i,j) of the recognized image data as a wavelet transform subject, and first performs a folding processing at both ends. This adds a value (dcb) to one of the ends and a value (edc) to the other end.

Here, because high-frequency components occur if a value of the pixel extremely changes at each of the ends, the folding processing is performed in order to prevent the occurrence.

The image processing device 1 uses a low-pass filter to perform a low-pass filtering on a row of pixels subjected to the folding processing, while using a high-pass filter to perform a high-pass filtering.

Then, there is obtained, as the transform coefficients, a transform coefficient (a′b′c′d′e′f′) in a frequency space on a low-frequency side and a transform coefficient (a″b″c″d″e″f″) in a frequency space on a high-frequency side.

Subsequently, the image processing device 1 thins out values on the low-frequency side by extracting the even-numbered places (starting at “0”) for a downsampling thereof, and thins out values on the high-frequency side by extracting the odd-numbered places for a downsampling thereof. This is because original image data can be generated by the inverse wavelet transform even after the downsampling.

The image data (abcdef) is thus divided into the low-frequency components (a′c′e′) and the high-frequency components (b″d″f″). In other words, the low-frequency components of the image data within the arbitrarily-shaped region are obtained as the transform coefficient in the frequency spaces on the low-frequency side, while the high-frequency components are obtained as the transform coefficient in the frequency space on the high-frequency side.

In the above description, the division is performed with the constant variable i in a j-direction (that is, the horizontal direction), and if the division is performed with respect to every value of the variable i, the arbitrarily-shaped region of the image data is divided in the horizontal direction.

Ina similar manner, the division is performed with the constant variable j in an i-direction (that is, the vertical direction), the arbitrarily-shaped region of the image data is divided in the vertical direction.

As described below, the image processing device 1 divides the arbitrarily-shaped region of the image data into the vertical direction the horizontal direction to perform the octave division on the region.

Note that the value of the pixel in the non-arbitrarily-shaped region 52 of FIG. 2B into which the watermark data is not to be embedded can be appropriately set to, for example, “0”.

Next, description is made of the octave division performed by the wavelet transform.

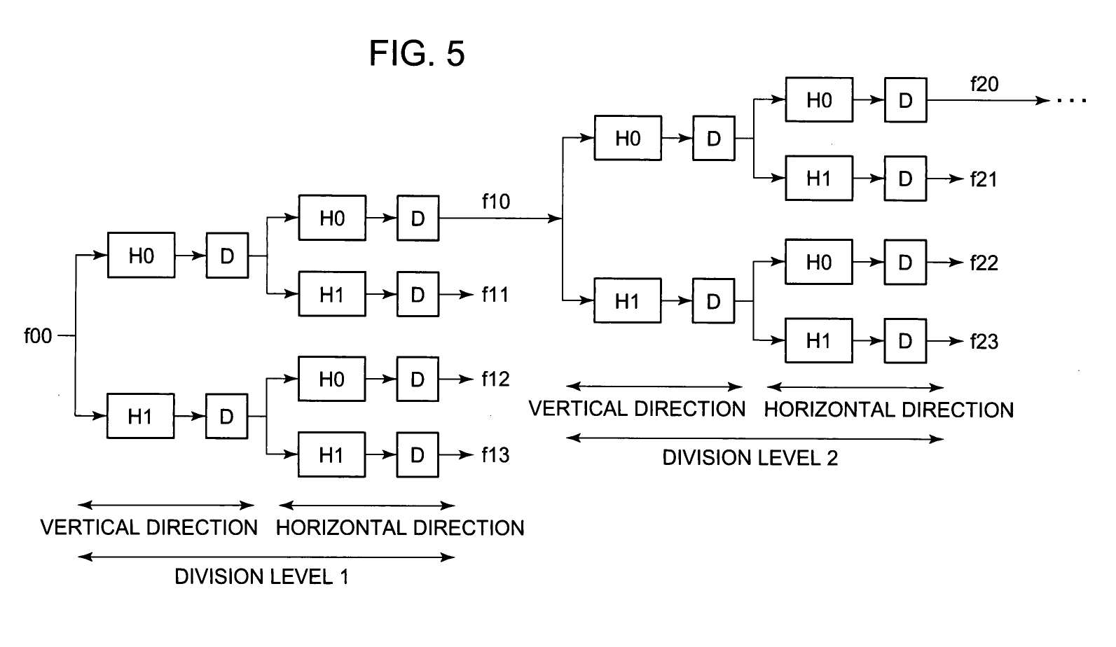

FIG. 5 illustrates an example of a filter bank obtained by combining filters, and the filter bank is used to filter the arbitrarily-shaped region of the image data, whereby the arbitrarily-shaped region of the image data is subjected to the octave division by the wavelet transform.

In FIG. 5, “H0” indicates the low-pass filter, and “H1” indicates the high-pass filter. In addition, “D” indicates that a downsampling is performed.

It is assumed that the image data corresponding to the arbitrarily-shaped region before being subjected to the wavelet transform is represented as f00(i,j) (hereinafter, referred to simply as “f00” or the like). Here, the first numeral succeeding “f” represents a division level (the number of octave divisions that have been performed; referred to also as “decomposition level”), and can be used as a number for identifying a frequency band.

The subsequent numeral is a number for identifying a frequency space.

For example, the frequency band with the first numeral “1” includes transform coefficients f10, f11, f12, and f13 in the four frequency spaces.

At a division level 1, the image processing device 1 folds the image data f00 in the vertical direction (that is, with the constant variable j in the i-direction), and then uses H0 to perform the low-pass filtering and the downsampling.

Then, the image processing device 1 folds the image data that has undergone the low-pass filtering in the horizontal direction (that is, with the constant variable i in the j-direction), and then uses H0 to perform the low-pass filtering and the downsampling. Meanwhile, after the folding processing, the image processing device 1 uses H1 to perform the high-pass filtering and the downsampling.

This produces: the transform coefficient f10 in the frequency space resulting from the low-pass filtering performed in the vertical direction and the horizontal direction; and the transform coefficient f11 in the frequency space resulting from the low-pass filtering performed in the vertical direction and the high-pass filtering performed in the horizontal direction.

Further, the image processing device 1 folds the image data f00, and then uses H1 to perform the high-pass filtering in the vertical direction and the downsampling.

Then, the image processing device 1 performs the folding processing in the horizontal direction on the image data that has undergone the high-pass filtering, and then uses H0 to perform the low-pass filtering and the downsampling, while after the folding processing, the image processing device 1 uses H1 to perform the high-pass filtering and the downsampling.

This produces: the transform coefficient f12 in the frequency space resulting from the high-pass filtering performed in the vertical direction and the low-pass filtering performed in the horizontal direction; and the transform coefficient f13 in the frequency space resulting from the high-pass filtering performed in the vertical direction and the horizontal direction.

In the above-mentioned manner, the image data f00 is divided into the transform coefficients f10, f11, f12, and f13 in the four frequency spaces, and a method of thus dividing the image data into four ¼'s is called “octave division”.

The frequency components of an image mainly exist on the low-frequency side, and hence main signals on the image data are included in f10.

Therefore, generally in the wavelet transform, the octave division is repeatedly performed further on a transform coefficient fn0 (n is a natural number).

Then, f10 is similarly subjected to the filtering, and transform coefficients f20, f21, f22, and f23 in the respective frequency spaces are generated at the division level 2.

Although not illustrated in the figure, by further dividing the transform coefficient f20, transform coefficients f30, f31, f32, and f33 are generated at a division level 3, and by thus repeating the division, the image data can be divided into frequency bands at a higher division level.

Next, description is made of an example of subjecting the image to the octave division.

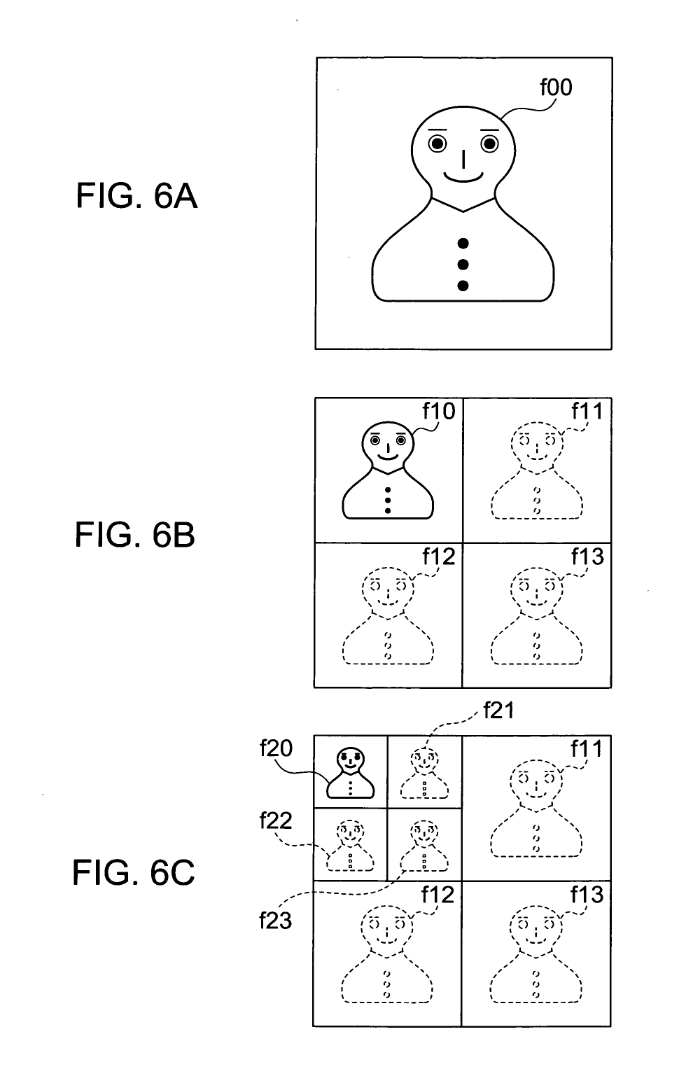

FIG. 6A is a diagram illustrating an image based on the image data f00 corresponding to the arbitrarily-shaped region before being divided.

FIG. 6B is a diagram illustrating images based on the transform coefficients f10, f11, f12, and f13 at the division level 1.

The respective transform coefficients in the frequency spaces at the division level 1 are obtained by subjecting the image data f00 to the octave division.

Main signal components of the image data f00 exist in f10 on the low-frequency side, and hence the image based on the transform coefficient f10 is indicated by the solid lines, while the images in the other frequency spaces are indicated by the broken lines.

FIG. 6C is a diagram illustrating images based on the transform coefficients f20, f21, f22, and f23 at the division level 2.

Image data at the division level 2 is obtained by subjecting the transform coefficient f10 to the octave division.

The main signal components of the image exist on the low-frequency side, and hence the image based on the transform coefficient f20 is indicated by the solid line, while the images in the other frequency spaces are indicated by the broken lines.

Although not illustrated in the figure, by further subjecting the transform coefficient f20 to the octave division, the frequency spaces corresponding to the transform coefficients f30, f31, f32, and f33 at the division level 3 are obtained.

Next, description is made of an example of subjecting the shape map to the octave division.

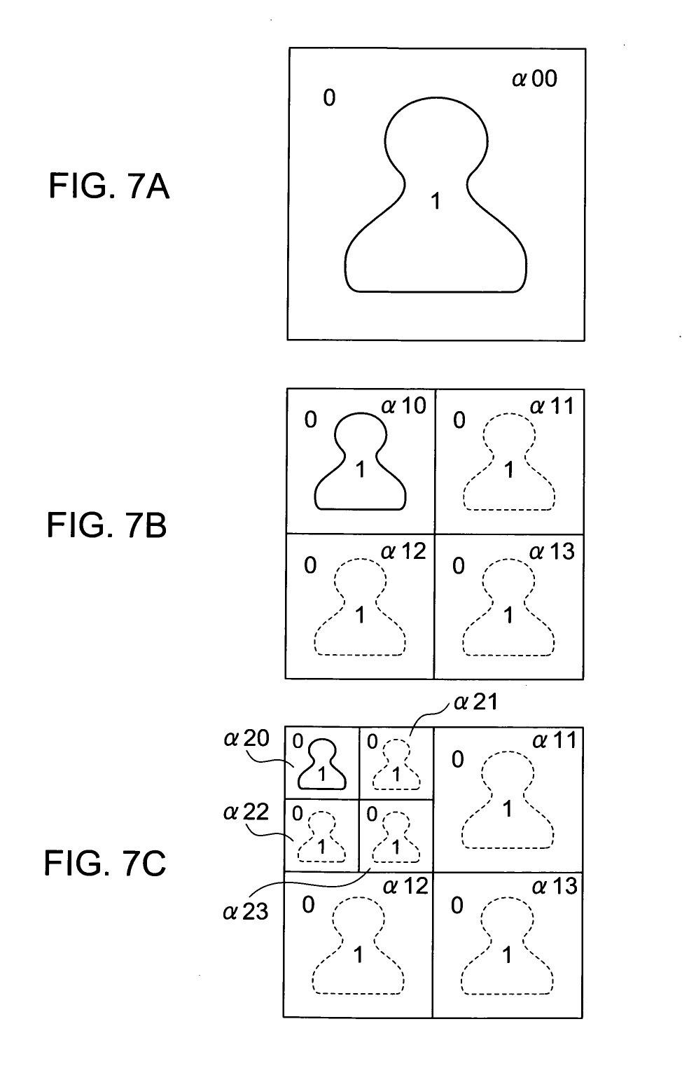

FIG. 7A is a diagram illustrating a shape map α00 before being divided.

The arbitrarily-shaped region to be subjected to the wavelet transform is defined by a region with the value “1”.

When the shape map α00 is subjected to the octave division, as illustrated in FIG. 7B, division shape maps α10, α11, α12, and α13 at the division level 1 are obtained.

In each of the division shape maps, the arbitrarily-shaped region is defined by the region with the value “1” in the corresponding frequency space.

For example, the region with the value “1” in the division shape map α10 defines the arbitrarily-shaped region in the frequency space corresponding to the transform coefficient f10, and the region with the value “1” in the division shape map α11 defines the arbitrarily-shaped region in the frequency space corresponding to the transform coefficient f11.

Therefore, for example, by putting the frequency space corresponding to the transform coefficient f10 into contrast with the division shape map α10, the image processing device 1 can recognize the arbitrarily-shaped region in the frequency space.

Further, when the division shape map α10 is subjected to the octave division, as illustrated in FIG. 7C, division shape maps α20, α21, α22, and α23 at the division level 2 are obtained.

Regions with the value “1” in the division shape maps α20, α21, α22, and α23 define the arbitrarily-shaped region in the frequency space corresponding to the transform coefficients f20, f21, f22, and f23, respectively.

Further, when the division shape map α20 is subjected to the octave division, the division shape maps at the division level 3 are obtained, which defines the arbitrarily-shaped region in the frequency space at the division level 3.

In the above description, the transform coefficient in the frequency space functions as division image data obtained by dividing the image data into which the watermark data is to be embedded into the frequency bands by the wavelet transform, the shape map functions as region data that defines a region into which the watermark data is to be embedded within the image data, and the division shape map functions as division region data obtained by dividing the region data into the frequency bands.

Accordingly, the image processing device 1 includes division image data acquiring means and division region data acquiring means.

Further, the image processing device 1 acquires the division region data (division shape maps) by dividing the region data (shape map) into the frequency bands.

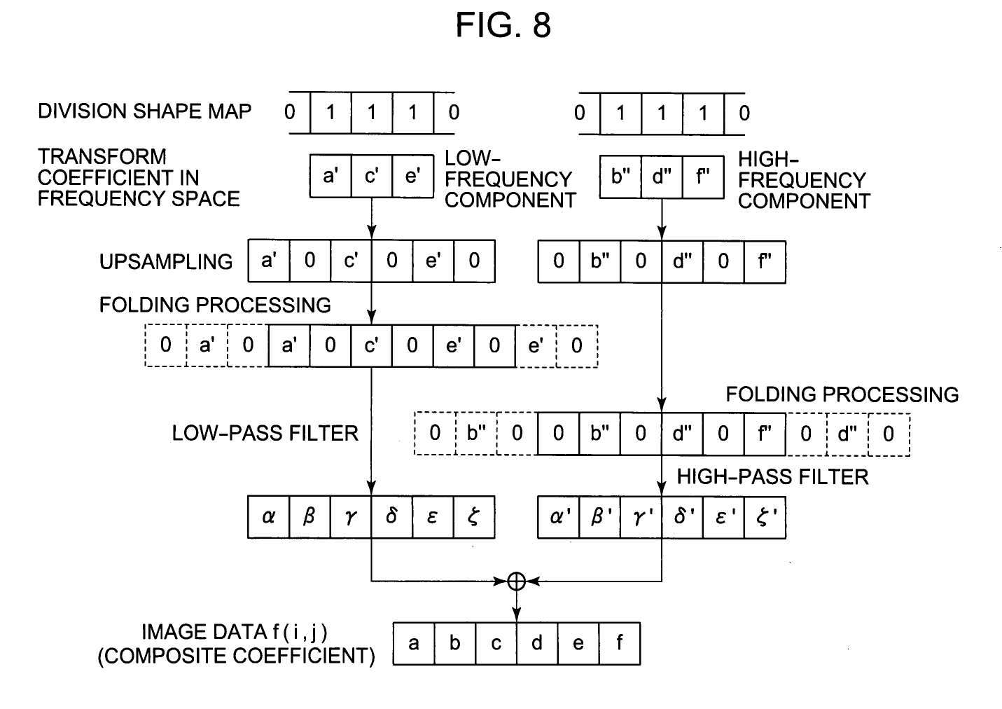

Next, FIG. 8 is used to describe a method of subjecting the arbitrarily-shaped region to the inverse wavelet transform.

Here, description is made of a case where an inverse transform is performed on the low-frequency components and the high-frequency components that are generated in FIG. 4.

First, there are prepared: the transform coefficients (low-frequency components and high-frequency components) in the frequency spaces; and the division shape maps in correspondence therewith.

The image processing device 1 extracts components in the frequency spaces corresponding to the pixel in which the division shape map has a value of “1”.

Thus obtained are the transform coefficient (a′c′e′) of the low-frequency components and the transform coefficient (b″d″f″) of the high-frequency components, which have been obtained by the previous wavelet transforms.

Subsequently, the image processing device 1 inserts “0” into the odd-numbered places of the obtained low-frequency components corresponding to the transform coefficient for an upsampling thereof, and further inserts “0” into the even-numbered places of the high-frequency components corresponding to the transform coefficient for an upsampling thereof.

Then, the image processing device 1 performs the folding processing on the low-frequency components and the high-frequency components that have been subjected to the upsampling, and then uses the low-pass filter to subject the low-frequency components to the low-pass filtering, while using the high-pass filter to subject the high-frequency components to the high-pass filtering.

Then, the image processing device 1 composites those filtered values, and computes a composite coefficient (abcdef).

The computed composite coefficient becomes the pixel f(i,j) of the original image data, which causes the original image data to be restored.

In the above description, the compositing is performed with the constant variable i in the j-direction (that is, the horizontal direction), and if the compositing is performed with respect to every value of the variable i, the arbitrarily-shaped region of the image data is composited in the horizontal direction.

In a similar manner, the compositing is performed with the constant variable j in the i-direction (that is, the vertical direction), the arbitrarily-shaped region of the image data is composited in the vertical direction.

When the compositing processing is applied to the frequency spaces illustrated in FIG. 6C, first, the transform coefficients f20, f21, f22, and f23 are composited to obtain the frequency spaces of FIG. 6B.

Further, when the compositing processing is applied to the frequency spaces FIG. 6B, the transform coefficients f10, f11, f12, and f13 are composited to restore the image data f00 of FIG. 6A.

Next, description is made of a division level desirable for embedding the watermark data in a frequency space.

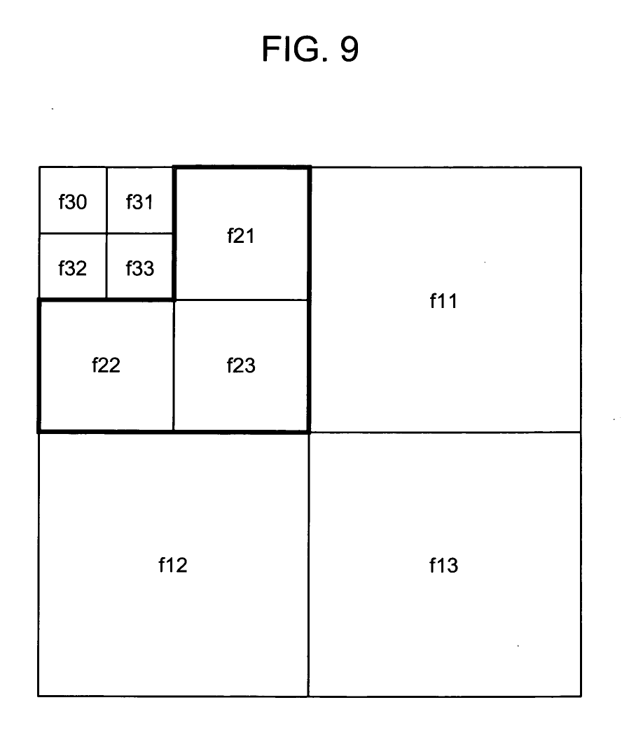

FIG. 9 is a diagram illustrating a state in which the image data f00 is divided up to the division level 3. However, in order to avoid the figure from becoming complicated, images (transform coefficients) are omitted.

As illustrated in FIG. 9, when the octave division is repeated three times, the frequency spaces corresponding to the transform coefficients f30 to f33, f21 to f23, and f11 to f13 are obtained.

The watermark data may be embedded into any one of the transform coefficients in the frequency spaces, but it is difficult on the high-frequency side to read the watermark data if the watermark data deviates in position, and hence it is desirable to avoid the transform coefficients f11 to f13 on the highest-frequency side when embedding the watermark data.

Meanwhile, when the watermark data is embedded into the frequency space on the low-frequency side, the watermark data becomes conspicuous. Therefore, for example, by embedding the watermark data into the transform coefficients f21 to f23 (indicated by the thick line) existing between the high-frequency side and the low-frequency side, it is possible to read the watermark data with stability without impairing visibility of the image.

Therefore, it is desirable that the frequency space into which the watermark data is to be embedded exist at an intermediate division level or a division level on a slightly-lower-frequency side than the intermediate division level.

Accordingly, the image processing device 1 can be configured to embed the watermark data into a predetermined frequency band, and here, embeds the watermark data into, as the predetermined frequency band, frequency bands excluding the frequency band of the highest frequency.

Alternatively, the image processing device 1 can be configured to embed the watermark data into a specified frequency band, for example, into the frequency band at the division level 2, or can be configured to embed the watermark data into a lower-frequency band than a specified frequency band, for example, into a lower-frequency band than a frequency band at a division level 4.

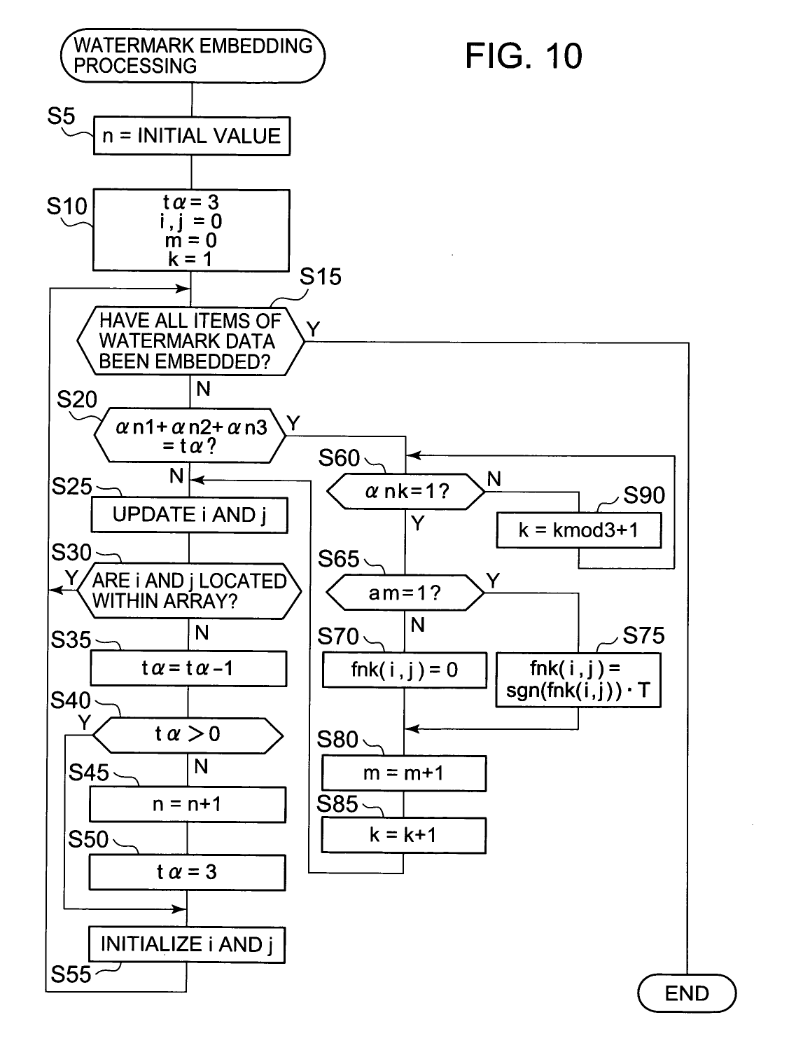

Next, FIG. 10 is used to describe a watermark embedding processing performed by the image processing device 1.

The following processing is performed by the CPU 2 (FIG. 1) according to the watermark embedding program.

First, the image processing device 1 stores the image data that has been divided up to a necessary division level, the shape map, and the watermark data in the data storage unit 12 (FIG. 1) for preparation.

The watermark data represents, for example, digital data expressed by a string of 0's and 1's such as (101001) or (0110011010). Here, the watermark data is expressed by “am” (where m=0, 1, 2, . . . ). For example, if the watermark data is (101), a0=1, a1=0, and a2=1.

Subsequently, the image processing device 1 sets an initial value of a division level “n” in order to identify the frequency band into which a watermark is to be embedded (Step S5).

The image processing device 1 embeds the watermark data into the frequency band at the division level n set as the initial value, and if the watermark data overflows, embeds the watermark data into the frequency band on the lower-frequency side one after another.

For example, by setting n=2 for a case as illustrated in FIG. 9 where the watermark data is embedded into the frequency band at the division level 2, if the watermark data overflows from the frequency band at the division level 2, the image processing device 1 also embeds the watermark data into the frequency space at the division level 3.

The initial value of n is, for example, set in the image processing device 1 by the user who desires to embed the watermark data, or set therein as a default value in advance.

Subsequently, the image processing device 1 sets tα to “3”, sets i and j to “0”, sets m to “0”, and sets k to “1” (Step S10).

Here, the variable tα represents a parameter for judging whether a position (pixel) within the frequency space is located inside the arbitrarily-shaped region or on a boundary thereof. It is desirable that the watermark data be embedded while avoiding the boundary wherever possible in order to avoid a read error, and hence tα is used in the judging. The judging method is described later.

Variables i and j represent parameters for indicating coordinates in the division shape map, the frequency space, or the like.

The variable m represents a parameter for indicating the watermark data am.

The variable k represents a parameter for identifying the three frequency spaces existing in the frequency band.

Subsequently, the image processing device 1 judges whether or not all items of the watermark data have been embedded (Step S15).

If all the items of the watermark data have been embedded (Step S15; Y), the image processing device 1 ends the watermark embedding processing.

Meanwhile, if there exist items of the watermark data which have not been embedded (Step S15; N), the image processing device judges whether or not αn1(i,j)+αn2(i,j)+αn3(i,j)=tα in the division shape map (Step S20). Note that (i,j) is omitted in the figure.

For example, assuming here that to is set to the initial value of 3 with i,j=0, the image processing device 1 judges whether or not αn1(0,0)+αn2(0,0)+αn3(0,0)=3.

This means that the image processing device 1 judges whether or not the value “3” is obtained by adding up the value corresponding to coordinate values (0,0) in the division shape map αn1, the value corresponding to coordinate values (0,0) in the division shape map an 2, and the value corresponding to coordinate values (0,0) in the division shape map αn3.

If the position of the coordinate values (0,0) is located inside the arbitrarily-shaped region, the values in the respective division shape maps are each “1” and are therefore added up to become the value “3”. If the position is located outside the arbitrarily-shaped region, the values in the respective division shape maps are each 0 and are therefore added up to become the value “0”.

Alternatively, if the position of the coordinates is located on the boundary of the arbitrarily-shaped region, it is expected that the value in a given division shape map be 0, while the value in the division shape map be 1, and hence an added-up value thereof becomes the values “1” or “2”.

In other words, the image processing device 1 judges that the position of the coordinates (i,j) is located inside the arbitrarily-shaped region if the added-up value is 3 in Step S20, outside the arbitrarily-shaped region if the added-up value is 0, and on the boundary of the arbitrarily-shaped region if the added-up value is 1 or 2.

Then, the image processing device 1 embeds the watermark data preferentially inside the boundary of the arbitrarily-shaped region.

Therefore, the image processing device 1 includes a boundary identifying means for identifying the boundary of the region into which the watermark data is to be embedded within the division image data (transform coefficients in the frequency spaces) with the use of the division region data (division shape map), and embeds the watermark data preferentially inside the identified boundary.

If the shape map satisfies αn1(i,j)+αn2(i,j)+αn3(i,j)=tα (Step S20; Y), the image processing device 1 judges whether or not αnk(i,j)=1 (Step S60).

If αnk (i,j) is not 1 (Step S60; N), the image processing device 1 sets k as k mod 3+1 (Step S90), and the procedure returns to Step S60, in which it is judged whether or not αnk=1 (Step S60).

Here, the variable “k mod 3” means a remainder obtained by dividing k by 3, the image processing device 1 performs, in Steps S60 and S90, such an operation as to judge whether or not αn2=1 unless αn1=1, and to further judge whether or not αn3=1 unless αn2=1.

For example, if tα=3, which is the initial value, it is judged in Step S60 that αnk1=1 because αn1=αn2=αn3=1.

If αnk(i,j) is 1 (Step S60; Y), the image processing device 1 judges whether or not am=1 (Step S65).

If am is not 1 (Step S65; N), that is, if am is 0, the image processing device 1 sets the value of fnk(i,j) as 0 (Step S70).

Meanwhile, if am is 1 (Step S65; Y), the image processing device 1 sets the value of fnk(i,j) as sgn(fnk(i,j))·T (Step S75).

Here, the variable sgn(fnk(i,j)) represents a code of the transform coefficient of fnk(i,j), which is one of positive and negative.

Then, the variable T represents an amplitude of the watermark data. A size of T is suitably set to be larger than in a case where the watermark is buried under noise and to be small to an extent that the watermark is inconspicuous in the image. This is decided by an experiment or the like.

As described above, the image processing device 1 embeds the watermark data into the frequency space by setting, if the watermark data is 0, fnk(i,j) corresponding thereto 0, and if the watermark data is 1, fnk(i,j) corresponding thereto 1.

Accordingly, the image processing device 1 acquires the division image data (transform coefficients in the frequency spaces) obtained by performing a division on the region (arbitrarily-shaped region) defined by the region data (shape map) within the image data to embed the watermark data into the division image data, and includes embedding means for embedding the watermark data into the division image data (transform coefficient in the frequency space) corresponding to the region defined by the division region data (division shape map).

After thus embedding the watermark data am, the image processing device 1 increments (increases) m by 1 (Step S80), and further increments k by 1 (Step S85), and the procedure advances to Step S25.

If αn1(i,j)+αn2(1, j)+αn3(i,j)=tα is not satisfied in Step S20 (Step S20; N), or after Step S85 is finished, the image processing device 1 updates the values of i and j (Step S25).

The updating is performed on the pixel α(i,j) by a predetermined amount in an inclusive manner by, for example, updating i with the constant variable j, and if i reaches an upper limit, incrementing j by 1 to further update i.

Subsequently, the image processing device 1 judges whether or not i and j are located within an array of the pixel α(i,j), that is, whether or not the coordinates (i,j) are located within the division shape map (Step S30).

If i and j are located within the array (Step S30; Y), with the procedure returning to Step S15, the image processing device 1 further resumes embedding the watermark data.

Meanwhile, if i and j are not located within the array (Step S30; N), the image processing device 1 decrements (decreases) ta by 1 (Step S35).

Further, the image processing device 1 judges whether or not ta after the decrementing is positive (Step S40), and if positive (Step S40; Y), initializes i and j to 0, and the procedure returns to Step S15, in which the watermark data embedding processing is performed.

Embedding the watermark data by decrementing tα by 1 (where tα≠0) means embedding the watermark data on the boundary of the arbitrarily-shaped region.

As described above, the image processing device 1 first embeds the watermark data inside the arbitrarily-shaped region from which the watermark data can be read with stability, and after that, if the watermark data overflows, embeds the watermark data on the boundary of the arbitrarily-shaped region.

Meanwhile, if ta is not positive (Step S40; N), that is, if tα=0, because the watermark data has been embedded inside the arbitrarily-shaped region and the entire boundary thereof, the image processing device 1 increments n by 1 (Step S45), sets tα to the initial value “3” (Step S50), and initializes i and j to “0” (Step S55), and the procedure returns to Step S15.

In other words, after finishing embedding the watermark into the frequency band at the division level n, the image processing device 1 shifts to the frequency band at the division level n+1 on the low-frequency side, and performs the watermark data embedding processing.

In the above-mentioned manner, the image processing device 1 can embed the watermark data into the frequency space of the arbitrarily-shaped region within the image data.

Then, the image processing device 1 can generate the image data having the frequency space in which the watermark data is embedded by performing the inverse wavelet transform on the transform coefficient in which the watermark data is embedded.

Accordingly, the image processing device 1 includes watermark-embedded image data generating means for generating the watermark-embedded image data by compositing the division image data (transform coefficients in the frequency spaces) in which the watermark data is embedded.

Note that in the above-mentioned example, the image processing device 1 subjects the arbitrarily-shaped region within the image data to the wavelet transform and embeds the watermark data into the arbitrarily-shaped region, but may be configured to perform the wavelet transform on an entirety of the image data including the arbitrarily-shaped region in a part thereof.

In this case, the image processing device 1 uses the division shape map to recognize the arbitrarily-shaped region in the frequency space, and embeds the watermark data into the region.

In this case, the image processing device 1 acquires the division image data (transform coefficients in the frequency spaces) obtained by dividing the entire image data, and embeds the watermark data into the region defined by the division region data (division shape map) within the division image data.

In this example, image data portion other than the arbitrarily-shaped region which constitutes a background of the arbitrarily-shaped region is also subjected to the wavelet transform and the inverse wavelet transform to be restored.

Meanwhile, in the example of subjecting the arbitrarily-shaped region to the wavelet transform, in a case where the watermark data is embedded into the part of the image data as the arbitrarily-shaped region, the image data constituting the background is omitted, and hence the image processing device 1 may be configured to paste an arbitrarily-shaped image in which the watermark data is embedded into a position of the arbitrarily-shaped region within the original image.

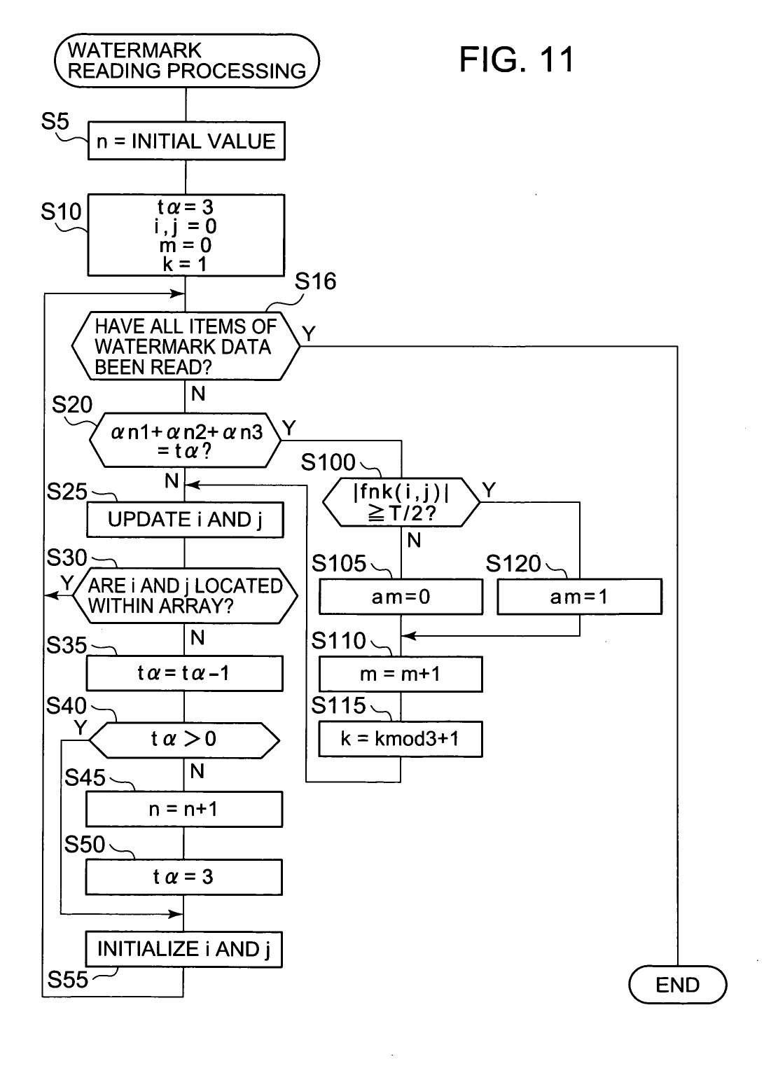

Next, a flowchart of FIG. 11 is used to describe a watermark reading processing performed by the image processing device 1.

The following processing is performed by the CPU 2 (FIG. 1) according to the watermark embedding program.

First, the image processing device 1 acquires the image data in which the watermark data is embedded, and prepares in advance the transform coefficients in the respective frequency spaces obtained by subjecting the image data to the octave division and the division shape map.

Accordingly, the image processing device 1 includes: watermark-embedded image data acquiring means for acquiring the watermark-embedded image data in which the watermark data is embedded; division watermark-embedded image data acquiring means for dividing the watermark-embedded image data into frequency bands by the wavelet transform and acquiring division watermark-embedded image data (transform coefficients in the frequency spaces); and the division region data acquiring means for acquiring the division region data (division shape maps) obtained by using the watermark-embedded image data to divide the region data (shape map) that defines the region in which the watermark data is embedded into the frequency bands.

Alternatively, the image processing device 1 may be configured to generate the division shape map by dividing the shape map, and in this case, the image processing device 1 acquires the division region data (division shape maps) by dividing the region data (shape map) into the frequency bands.

Hereinafter, the same processing step as in FIG. 10 is denoted by the same step number, and description thereof is simplified or omitted.

First, the image processing device 1 sets n to the initial value (Step S5). The value of n is previously set on the image processing device 1 by obtaining the value that has been used for embedding the watermark data.

Then, the image processing device 1 sets the values of tα, j, m, and k to the initial values (Step S10).

Further, although not illustrated in the figure, it is assumed that a bit number of the embedded watermark data and the amplitude T of the watermark data have been also obtained and set on the image processing device 1.

Subsequently, the image processing device 1 judges whether or not all the items of the watermark data have been read (Step S16).

The image processing device 1 performs the judgment by judging whether or not the bit number of the read watermark data has reached a preset bit number.

If all the items of the watermark data have been read (Step S16; Y), the image processing device 1 ends the watermark reading processing.

If there is an item of the watermark data that has not yet been read (Step S16; N), the image processing device 1 judges whether or not the shape map satisfies αn1(i,j)+αn2(i,j)+αn3(i,j)=tα (Step S20).

As described above, the image processing device 1 includes the boundary identifying means for identifying the boundary of the region in which the watermark data is embedded within the division watermark-embedded image data (transform coefficients in the frequency spaces) with the use of the division region data (division shape map), and reads the watermark data from inside the identified boundary in a similar manner to the watermark data embedding processing.

If it is judged in Step S20 that the added-up value is tα, the image processing device 1 judges whether or not |fn(i,j)|, that is, the absolute value of fn(i,j) is equal to or larger than T/2 (Step S100).

Then, if |fn(i,j)| is smaller than T/2 (Step S100; N), the image processing device 1 sets am to 0 (Step S105), and if |fn(i,j)| is larger than T/2 (Step S100; Y), the image processing device 1 sets am to 1 (Step S120).

It is set here that a threshold value for judging the 0-1 of the bit is set as T/2, which is a mere example, and the threshold value may be set more appropriately by an experiment or the like.

As described above, the image processing device 1 acquires the division watermark-embedded image data (the transform coefficients in the frequency spaces) obtained by dividing the region defined by the region data (shape map) within the watermark-embedded image data, reads the watermark data from the division watermark-embedded image data, and includes reading means for reading the watermark data from the division watermark-embedded image data (transform coefficients in the frequency spaces) corresponding to the regions defined by the division region data (division shape maps).

After reading the watermark data am, the image processing device 1 thus increments m by 1 (Step S110), and further increments k by 1 (Step S115), and the procedure advances to Step S25.

The subsequent steps are the same as those of FIG. 10. According to the above-mentioned processing, it is possible to read the watermark data am (m=0, 1, . . . ) embedded in the image data.

Note that in the above-mentioned example, the image processing device 1 subjects the arbitrarily-shaped region within the watermark-embedded image data to the wavelet transform and reads the watermark data from the arbitrarily-shaped region, but may be configured to perform the wavelet transform on an entirety of the image data including the embedded arbitrarily-shaped region in a part thereof.

In this case, the image processing device 1 uses the division shape map to recognize the arbitrarily-shaped region in the frequency space, and reads the watermark data from the arbitrarily-shaped region.

In this case, the image processing device 1 acquires the division watermark-embedded image data obtained by dividing an entirety of the watermark-embedded image data including in its part the arbitrarily-shaped region in which the watermark data is embedded, and reads the watermark data from the region defined by the division region data (division shape map) within the division watermark-embedded image data.

Next, description is made of an example of utilizing the image data in which the watermark data is embedded.

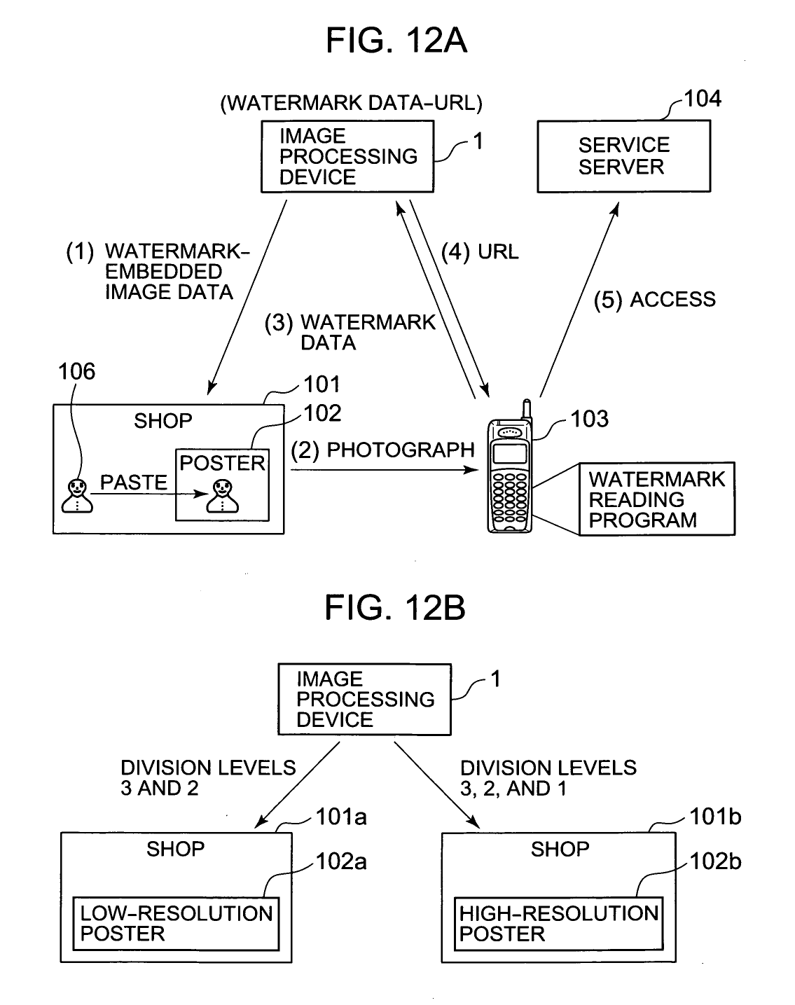

FIG. 12A is a diagram illustrating an example of an information processing system that allows a cellular phone 103 to photograph a poster 102 in which the watermark data is embedded, and connects the cellular phone 103 to a website hosted on a service server 104. Hereinafter, the description is made in the order of parenthesized numbers illustrated in FIG. 12A.

(1) First, the image processing device 1 prestores the watermark data and a uniform resource locator (URL) of the website on the service server 104 in association with each other.

Then, the image processing device 1 embeds the watermark data into the image data having an arbitrary shape, and transmits the watermark-embedded image data to a terminal at a shop 101.

The shop 101 receives the watermark-embedded image data by the terminal, and uses the watermark-embedded image data to print an arbitrarily-shaped image 106. Then, the shop 101 pastes the arbitrarily-shaped image 106 on the poster 102 to complete the poster 102.

(2) The user visits the shop 101, and photographs the poster 102 with the cellular phone 103 having a camera function and a network connection function.

(3) The cellular phone 103 has the watermark reading program installed thereon, and also stores data necessary to read the watermark data which includes the initial value of n and the shape map.

Then, the cellular phone 103 uses the shape map to extract the region of the arbitrarily-shaped image 106 from the poster 102, performs the wavelet transform thereon, and reads the watermark data therefrom.

Then, the cellular phone 103 transmits the read watermark data to the image processing device 1.

(4) The image processing device 1 receives the watermark data from the cellular phone 103, retrieves the URL associated therewith, and transmits the URL to the cellular phone 103.

(5) The cellular phone 103 receives the URL from the image processing device 1, and uses the URL to access the website on the service server 104.

Accordingly, in the information processing system, it is possible to use the watermark-embedded image data to thereby lead the user to a predetermined website.

According to the information processing system, for example, a food-products company provides a business entity that owns the image processing device 1 with the URL and the image to be printed on the poster 102, and requests a permit to display the poster 102 in the shop 101.

Then, the food-products company can provide the user accessing through the cellular phone 103 with an advertisement or a campaign for the company's product on the website hosted on the service server 104 by the company.

Next, description is made of an example of providing a service by using characteristics of the wavelet transform.

The wavelet transform, in which the image data is divided into the frequency bands, can cause a resolution of the image to be adjusted by selection of frequency bands to be composited.

For example, among the transform coefficients illustrated in FIG. 9, the main signal components are included in the transform coefficient f30 on the lowest-frequency side, and when the transform coefficient f30 is printed, an image having a low resolution is printed.

Then, if the transform coefficient f30 with which the transform coefficients f31, f32, and f33 are composited is printed, the resolution is improved.

In addition, if the transform coefficient f30 with which the transform coefficients f21, f22, and f23 are composited is printed, the resolution is further improved.

As described above, in the wavelet transform, the resolution is further improved each time the transform coefficient on the lower-frequency side is composited with other transform coefficients on the higher-frequency side.

Therefore, after embedding the watermark data into the image data, the image processing device 1 of FIG. 12B retains the image data being divided into the frequency bands without performing the inverse wavelet transform thereon.

For example, it is assumed that the image data is divided into a frequency bands at the division level 3, and that the watermark data is embedded in the frequency band at the division level 2.

Then, a shop 101a notifies the image processing device 1 that a low-resolution image suffices. Then, the image processing device 1 transmits the transform coefficients at the division levels 3 and 2 to the terminal at the shop 101a.

The terminal at the shop 101a receives the transform coefficients from the image processing device 1, performs the inverse wavelet transform thereon, and restores the low-resolution watermark-embedded image data. Then, a low-resolution poster 102a is printed.

In addition, a shop 101b needs a high-resolution image, and notifies the image processing device 1 to that effect. Then, the image processing device 1 transmits the transform coefficients at the division levels 3, 2, and 1 to the shop 101b.

The terminal at the shop 101b receives the transform coefficients from the image processing device 1, performs the inverse wavelet transform thereon, and restores the high-resolution watermark-embedded image data. Then, the high-resolution poster 102b is printed.

In this example, the inverse wavelet transform is performed by the terminal at the shops, but the image processing device 1 may be configured to generate the watermark-embedded image data having a necessary resolution by the inverse wavelet transform, and to transmit the resultant to the shop 101a or the shop 101b.

Accordingly, by configuring the image processing device 1 to transmit data according to the necessary resolution, it is possible to save a data communication amount and a communication time, and to thereby achieve a reduction in cost.

However, in order to cause the image to be printed with the watermark embedded therein, the image processing device 1 transmits data more than the data in the frequency bands in which the watermark data is embedded.

In addition, a watermark-embedded image can be not only printed by offset printing and the like, but also output from various printers (including a thermal printer, an inkjet printer, and an electrophotographic printer).

Further, the watermark-embedded image can be read by a scanner to be transmitted via network and printed, and duplication is possible by copying the watermark-embedded image by a copier.

In addition, the watermark-embedded image can be displayed by a digital signage. Here, the “digital signage” refers to a technology for displaying an advertisement by advertisement media using digital communications, for example, displaying an advertisement movie by using a flat display, a projector, or the like, and is becoming a focus of attention as an advertisement technology to substitute the conventional printed poster.

Further, it is possible to provide the user with the watermark data by a medium on which printing is performed in two stages. In this case, for example, the information processing system can be configured in such a manner that paper on which a shop logo in which the watermark data has been embedded is printed is prepared as receipt paper, and that checkout contents and the like are subsequently printed on the receipt paper by a thermal printer to output a receipt. Accordingly, the information processing system can be configured not only to embed an electronic watermark into the printed image, but also to form the image in which the electronic watermark is embedded by printing additional information on the printed paper.

According to this embodiment described above, the following effects can be obtained.

(1) The wavelet transform allows the watermark data to be embedded into the arbitrarily-shaped region of the image.

(2) The wavelet transform allows the watermark data embedded in the arbitrarily-shaped region of the image to be read.

(3) By using the shape map, it is possible to define the arbitrarily-shaped region into which the watermark data is to be embedded in the frequency space of the image data.

(4) By using the shape map, it is possible to define the arbitrarily-shaped region in which the watermark data is embedded in the frequency space of the image data.

(5) By checking the division shape map, it is possible to judge whether or not a given position is inside the arbitrarily-shaped region or on the boundary thereof in the frequency space of the image data, and to embed the watermark data preferentially inside the arbitrary shape.

(6) It is possible to set the frequency band into which the watermark data is to be embedded, and to embed the watermark data without using the frequency band on the high-frequency side on which a reading error is liable to occur.

(7) It becomes possible to embed and extracts the watermark data without impairing visibility of the image to be embedding target.

(8) Original design properties of the image can be maintained because there is no need to divide the image into rectangle block shapes, while textures thereof can be maintained because the watermark data is embedded into the frequency space, and hence there is no fear that the design properties be impaired.

(9) It is possible to perform a high-definition watermark-data detection by embedding the watermark data into the arbitrarily-shaped image while avoiding the high-frequency band.

What is claimed is:

1. An image processing device, comprising:
division image data acquiring means for acquiring division image data obtained by dividing image data into which watermark data is to be embedded into frequency bands by a wavelet transform;
division region data acquiring means for acquiring division region data obtained by dividing, into the frequency bands, region data that defines a region into which the watermark data is to be embedded within the image data; and
embedding means for embedding the watermark data into the division image data corresponding to a region defined by the acquired division region data.

2. An image processing device according to claim 1, wherein:
the division image data acquiring means acquires the division image data obtained by dividing the region defined by the region data within the image data; and
the embedding means embeds the watermark data into the acquired division image data.

3. An image processing device according to claim 1, wherein:
the division image data acquiring means acquires the division image data obtained by dividing an entirety of the image data; and
the embedding means embeds the watermark data into the region defined by the acquired division region data within the division image data.

4. An image processing device according to claim 1, further comprising boundary identifying means for identifying, with use of the acquired division region data, a boundary of the region into which the watermark data is to be embedded within the division image data,
wherein the embedding means embeds the watermark data preferentially inside the identified boundary.

5. An image processing device according to claim 1, wherein the division region data acquiring means acquires the division region data by dividing the region data into the frequency bands.

6. An image processing device according to claim 1, wherein the embedding means embeds the watermark data into a predetermined frequency band.

7. An image processing device according claim 1, further comprising watermark-embedded image data generating means for generating watermark-embedded image data by compositing the division image data in which the watermark data is embedded by the embedding means.

8. An image processing device, comprising:
watermark-embedded image data acquiring means for acquiring watermark-embedded image data in which watermark data is embedded;
division watermark-embedded image data acquiring means for acquiring division watermark-embedded image data by dividing the acquired watermark-embedded image data into frequency bands by a wavelet transform;
division region data acquiring means for acquiring division region data obtained by dividing, into the frequency bands, region data that defines a region in which the watermark data is embedded within the watermark-embedded image data; and
reading means for reading the watermark data from the division watermark-embedded image data corresponding to a region defined by the acquired division region data.

9. An image processing device according to claim 8, wherein:
the division watermark-embedded image data acquiring means acquires the division watermark-embedded image data obtained by dividing the region defined by the region data within the acquired watermark-embedded image data; and
the reading means reads the watermark data from the acquired division watermark-embedded image data.

10. An image processing device according to claim 8, wherein:
the division watermark-embedded image data acquiring means acquires the division watermark-embedded image data obtained by dividing an entirety of the watermark-embedded image data; and
the reading means reads the watermark data from the region defined by the acquired division region data within the division watermark-embedded image data.

11. An image processing device according to claim 8, further comprising boundary identifying means for identifying, with use of the acquired division region data, a boundary of the region in which the watermark data is embedded within the division watermark-embedded image data,
wherein the reading means reads the watermark data from inside the identified boundary.

12. An image processing device according to claim 8, wherein the division region data acquiring means acquires the division region data by dividing the region data into the frequency bands.

13. An image processing program for causing a computer to implement:
a division image data acquiring function of acquiring division image data obtained by dividing image data into which watermark data is to be embedded into frequency bands;
a division region data acquiring function of acquiring division region data obtained by dividing, into the frequency bands, region data that defines a region into which the watermark data is to be embedded within the image data; and
an embedding function of embedding the watermark data into the division image data corresponding to a region defined by the acquired division region data.

14. An image processing program for causing a computer to implement:
a watermark-embedded image data acquiring function of acquiring watermark-embedded image data in which watermark data is embedded;
a division watermark-embedded image data acquiring function of acquiring division watermark-embedded image data by dividing the acquired watermark-embedded image data into frequency bands;
a division region data acquiring function of acquiring division region data obtained by dividing, into the frequency bands, region data that defines a region in which the watermark data is embedded within the watermark-embedded image data; and
a reading function of reading the watermark data from the division watermark-embedded image data corresponding to a region defined by the acquired division region data.
